(19) United States
(12) Patent Application Publication
(10) Pub. No.: US 2014/0049493 A1
(43) Pub. Date: Feb. 20, 2014

(54) INFORMATION DEVICE, AND COMPUTER-READABLE STORAGE MEDIUM FOR COMPUTER PROGRAM

(71) Applicant: KONICA MINOLTA, INC., Chiyoda-ku (JP)

(72) Inventor: Nobuhiro NOJIMA, Amagasaki-shi (JP)

(73) Assignee: KONICA MINOLTA, INC., Chiyoda-ku (JP)

(21) Appl. No.: 13/956,863

(22) Filed: Aug. 1, 2013

(30) Foreign Application Priority Data
Aug. 17, 2012 (JP) 2012-180917

(51) Int. Cl. G09G 5/00

(52) U.S. Cl. CPC G09G 5/006
USPC 345/173

(57) ABSTRACT

An information device includes a touch-sensitive panel that is used for display and operation; an operation check portion configured to check whether operation performed on the information device is first operation that is predefined operation or second operation other than the first operation; and a luminance setting portion configured to, when a luminance set value of the touch-sensitive panel is set at a low luminance value that is set for a case of power saving, and when the operation check portion checks that the operation performed on the information device is the first operation, remain the luminance set value unchanged, and, when the luminance set value is set at the low luminance value, and when the operation check portion checks that the operation performed on the information device is the second operation, set, as the luminance set value, a high luminance value greater than the low luminance value.

This application is based on Japanese patent application No. 2012-180917 filed on Aug. 17, 2012, the contents of which are hereby incorporated by reference.

### BACKGROUND OF THE INVENTION

1. Field of the Invention

The present invention relates to an information device with a touch-sensitive panel that is used for display and operation.

2. Description of the Related Art

Mobile information devices, such as a tablet personal computer and a smartphone, are called multifunctional terminals. Such mobile information devices are provided with a touch-sensitive panel functioning as primary operation means. The touch-sensitive panel herein is an input/output device having a single-piece construction of a touchpad pointing device and a display unit such as a liquid crystal panel. The front face of the touch-sensitive panel functions both as a screen on which an image used as an operating screen is displayed and as a touch screen on which a user makes operation. The indication on the operating screen on the touch-sensitive panel is modified appropriately in accordance with the operation by the user.

In general, a multifunctional terminal has a power-saving function to automatically reduce the luminance of displays made therein, as with other mobile devices having a display unit. Suppose that, in a state where a normal luminance display is made on a screen, a user does not perform any operation in a multifunctional terminal during a predetermined period of time. In such a case, the power-saving function works to reduce the luminance of the display made in the screen. Stated differently, the power supplied from a battery to the display unit of the multifunctional terminal is reduced. When the user performs some sort of operation in the multifunctional terminal in a power-saving state where the screen is dim, the current value of the luminance returns to a normal value to make the display in the screen legible.

As for luminance value control through which the power consumption in a mobile device is reduced, there is known a technology for changing a luminance value depending on what is displayed in the mobile device. There is proposed a technology for providing a user with a screen having the optimum legibility by changing a luminance value in a mobile terminal for each piece of application software (hereinafter referred to as an application) corresponding to a function of a telephone, browser, image viewer, or camera (Japanese unexamined patent application publication No. 2007-150831).

According to control on luminance of displays by using conventional power-saving functions, when a user performs some sort of operation in a power-saving state where a luminance value is reduced compared to a normal luminance value, the luminance returns to the normal luminance value independently of the type of the operation. In short, the conventional luminance control is as follows: The state where the user performs some sort of operation is regarded as a state where the user looks at a screen, and therefore, a power-saving mode is cancelled in response to the operation by the user to improve the legibility on the screen.

However, even when the user performs operation, increasing the luminance of displays to improve the legibility on the screen is sometimes unnecessary. Returning the luminance value to a normal value although it is unnecessary for the user means wasting the power.

The case where returning the luminance value to a normal value is unnecessary is, for example, a case where a user performs operation without looking at the touch-sensitive panel. For example, a user of a mobile information device makes a presentation while enlarging, in a projector or large-sized display monitor, a display made on the touch-sensitive panel. In such a situation, the user probably performs touch operation while looking at the enlarged display without looking at the display made on the touch-sensitive panel. Alternatively, the user probably does not look at the touch-sensitive panel when he/she performs operation which does not require him/her to touch a specific position of the touch-sensitive panel such as scrolling the screen with a flick of the finger.

Another example of the case where returning the luminance value to a normal value is unnecessary is a case where a user does not have to perform another operation subsequently, i.e., a case where no-operation state possibly continues. Such a case is, for example, a case of shutting down a program running, or a case of closing a window prompting the user to check, namely, a case where operation for giving a command to perform self-contained processing. In such a case, the user is less interested in indication on the screen than in a case of operation for launching an application or for opening a window. Therefore, from the viewpoint of reduction in power consumption, it is preferable to maintain the power-saving state until another operation is performed later.

### SUMMARY

The present disclosure has been achieved in light of such an issue, and therefore, an object of an embodiment of the present invention is to increase the utility of a power-saving function through which, when no-operation state continues, luminance of displays is reduced.

According to an embodiment of the present invention, an information device includes a touch-sensitive panel that is used for display and operation; an operation check portion configured to check whether operation performed on the information device is first operation that is predefined operation or second operation other than the first operation; and a luminance setting portion configured to, when a luminance set value of the touch-sensitive panel is set at a low luminance value that is set for a case of power saving, and when the operation check portion checks that the operation performed on the information device is the first operation, remain the luminance set value unchanged, and, when the luminance set value is set at the low luminance value, and when the operation check portion checks that the operation performed on the information device is the second operation, set, as the luminance set value, a high luminance value greater than the low luminance value.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the configuration of a display system according to an embodiment of the present invention.

FIG. 2 is a diagram showing an example of the functional configuration of a tablet according to a first embodiment.

FIG. 3 is a diagram showing a first example of classification information.

FIG. 4 is a diagram showing an example of luminance set values.

FIG. 5 is a flowchart depicting an example of luminance control operation (A1) in a tablet according to the first embodiment.

FIG. 6 is a flowchart depicting an example of a high luminance setting routine in the luminance control operation (A1).

FIG. 7 is a flowchart depicting an example of a low luminance setting routine in the luminance control operation (A1).

FIG. 8 is a flowchart depicting an example of an operation check routine (a) in the luminance control operation (A1).

FIG. 9 is a diagram showing a modification to the functional configuration of the tablet according to the first embodiment.

FIG. 10 is a diagram showing a second example of classification information.

FIG. 11 is a flowchart depicting an example of another luminance control operation (A2) according to the first embodiment.

FIG. 12 is a flowchart depicting an example of a luminance setting routine (a) in the luminance control operation (A2).

FIG. 13 is a diagram showing an example of the functional configuration of a tablet according to a second embodiment.

FIG. 14 is a diagram showing a third example of classification information.

FIG. 15 is a flowchart depicting an example of luminance control operation (B1) in a tablet according to the second embodiment.

FIG. 16 is a flowchart depicting an example of a luminance setting routine (b) in the luminance control operation (B1).

FIG. 17 is a flowchart depicting an example of an operation check routine (b) in the luminance setting routine (b).

FIG. 18 is a diagram showing a modification to the functional configuration of the tablet according to the second embodiment.

FIG. 19 is a flowchart depicting an example of another luminance control operation (B2) according to the second embodiment.

FIG. 20 is a flowchart depicting a modification to the luminance control operation (A1).

### DESCRIPTION OF THE PREFERRED EMBODIMENTS

In this description, an information device with a touch-sensitive panel is, for example, a tablet personal computer (hereinafter, referred to as a tablet). The tablet is provided with a Central Processing Unit (CPU) for executing computer programs and an operating system for running applications. A user of the tablet is able to install a desired application suitable for the operating system onto the tablet.

### First Embodiment

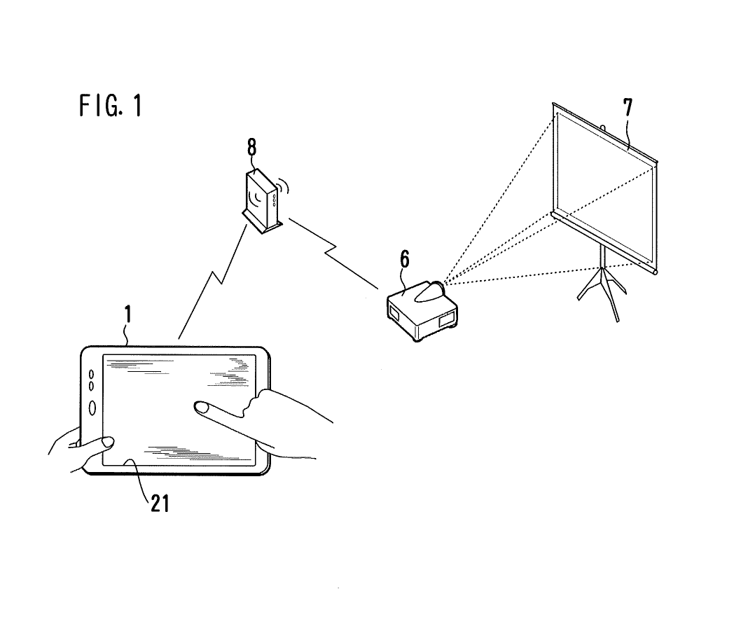

FIG. 1 shows an example of a display system in which a tablet 1, a projector 6, and so on are provided. The projector 6 is connected, as an external display unit, to the tablet 1 through a wireless Local Area Network (LAN), for example. In the illustrated example, the tablet 1 and the projector 6 perform communication with each other via an access point 8. Instead of this, however, it is possible to connect the tablet 1 to the projector 6 for communication therebetween through other means such as a LAN cable, a Universal Serial Bus (USB) cable, or a Bluetooth.

The tablet 1 offers a touch-sensitive panel 21 having a size corresponding to a major part of the front face of the tablet 1. As long as the tablet 1 is connected to the projector 6, a screen display (image) appearing on the touch-sensitive panel 21 is projected onto a screen 7 by the projector 6, so that the magnified image appears on the screen. When the display on the touch-sensitive panel 21 is changed, the display on the screen 7 is also changed almost at the same time with the change on the touch-sensitive panel 21.

The touch-sensitive panel 21 is provided with a display unit in which a liquid crystal panel is combined with a backlight for changing luminance. The touch-sensitive panel 21 is also provided with a pointing device in which a signal circuit board is attached to a project-type capacitive touchpad. The touch-sensitive panel 21 has multi-touch capabilities to recognize two simultaneous finger touches.

The display system of this type is used for a variety of presentations. In order to make a presentation in a meeting, training course, item briefing, or workshop, a person who makes the presentation prepares a document in advance. The person causes the document to be displayed on the tablet 1, and also causes the document to be displayed on the screen 7 to show the document to audiences. The person performs predetermined operation on the touch-sensitive panel 21 of the tablet 1 to scroll the screen, to switch between pages to be displayed as screen displays, to enlarge a part of a screen, and to move a pointer in the screen.

The tablet 1 is equipped with power-saving functions to reduce the power consumption. One of the power-saving functions is to automatically control luminance of displays made in the touch-sensitive panel 21 in accordance with operation performed thereon. The automatic luminance control is basically switching between high luminance and low luminance. The luminance is controlled at high luminance for the case where a display should be legible. The luminance is controlled at low luminance for the case where a display should not be legible. Hereinafter, the configuration and operation of the tablet 1 related to the luminance control is described in more details.

In the first embodiment, the function to control luminance automatically depending on operation is implemented by an application for power-saving specialized for the function. The application for power-saving is downloaded from, for example, a server, and is installed onto the tablet 1. The application thus installed obtains, from the operating system, information showing what kind of operation the user performed.

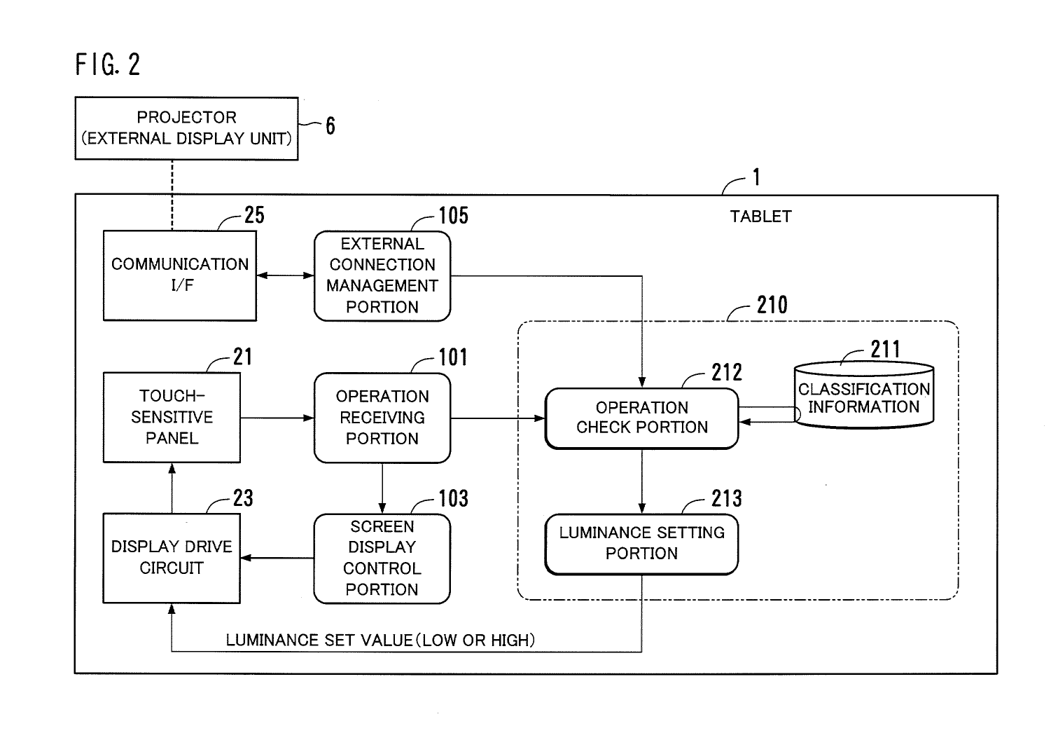

FIG. 2 shows an example of the functional configuration related to the luminance control in the tablet 1. As shown in FIG. 2, the tablet 1 is configured of an operation receiving portion 101, a screen display control portion 103, an external connection management portion 105, classification information 211, an operation check portion 212, a luminance setting portion 213, and so on. The operation receiving portion 101, the screen display control portion 103, and the external connection management portion 105 are functional elements implemented primarily by the operating system. The classification information 211, the operation check portion 212, and the luminance setting portion 213 are preloaded into the tablet 1 by installing an application 210 for power-saving. The operation check portion 212 and the luminance setting portion 213 are functional elements implemented in response to execution of the application 210 by the CPU of the tablet 1. The classification information 211 is so stored in a nonvolatile memory of the tablet 1 that the operation check portion 212 can refer to the classification information 211.

The operation receiving portion 101 accepts user's operation on the touch-sensitive panel 21. To be specific, the operation receiving portion 101 checks the details of the operation based on data indicating the touched position outputted from the touch-sensitive panel 21, and conveys the result of check to the screen display control portion 103. To be more specific, the operation receiving portion 101 checks which type of the actions below the movement (gesture) of user's hand for the operation corresponds to. The actions are, for example, “tap” of hitting one spot of the screen lightly; “hold” of pressing the screen for a certain of time; “drag” of moving user's finger from an area of the screen to another with the finger touching the screen, and “flick” of moving the finger quickly and linearly on the screen. The type of action checked by the operation receiving portion 101 and the touched position are conveyed, as the result of check, to the screen display control portion 103.

The screen display control portion 103 controls the display drive circuit 23 to display a screen appropriate to a request. The display driving circuit 23 serves to drive the display unit of the touch-sensitive panel 21. When receiving the result of check indicating the details of the operation from the operation receiving portion 101, the screen display control portion 103 conveys the result of check to software which is the current operation target. To be specific, the screen display control portion 103 conveys the details of the operation to an application (not shown) corresponding to the foreground window which is a screen visible in the foreground on the touch-sensitive panel 21. Upon the receipt of the details of the operation, the application performs a process of analyzing user's instructions and a process in response to the instructions. During the processes, the application requests the screen display control portion 103 to change the indication on the display if necessary. In response to the request, the screen display control portion 103 controls the display drive circuit 23.

Suppose that, for example, the current operation target application is a launcher for displaying a list of icons corresponding to applications installed on the tablet 1, and a user taps his/her finger on one icon. Tapping on the icon means selecting an application corresponding to the icon. In such a case, the launcher starts the selected application, and requests the screen display control portion 103 to display a screen in which the icon is highlighted in order to show that the selection is accepted. The screen display control portion 103 then responds to the request.

The external connection management portion 105 monitors a state of the communication via the communication interface 25 between the tablet 1 and an external device. While the tablet 1 and a certain external device are connected to each other for communication, the external connection management portion 105 receives an inquiry from the operation check portion 212 and provides the same with identification information on the external device connected.

The power-saving application 210 exemplified in FIG. 2 is software to reduce unnecessary power consumption while a presentation is made. Stated differently, only while the tablet 1 is used for a presentation, the application 210 controls luminance of the touch-sensitive panel 21. From the standpoint of the application 210, the time when the tablet 1 is used for a presentation is a time at which the tablet 1 is connected to the projector 6, a large-screen television, a large monitor, or another external display unit. The external display unit herein is, for example, a mobile information device possessed by each participant in the presentation. It is not necessary that the external display unit have a screen larger than that of the tablet 1.

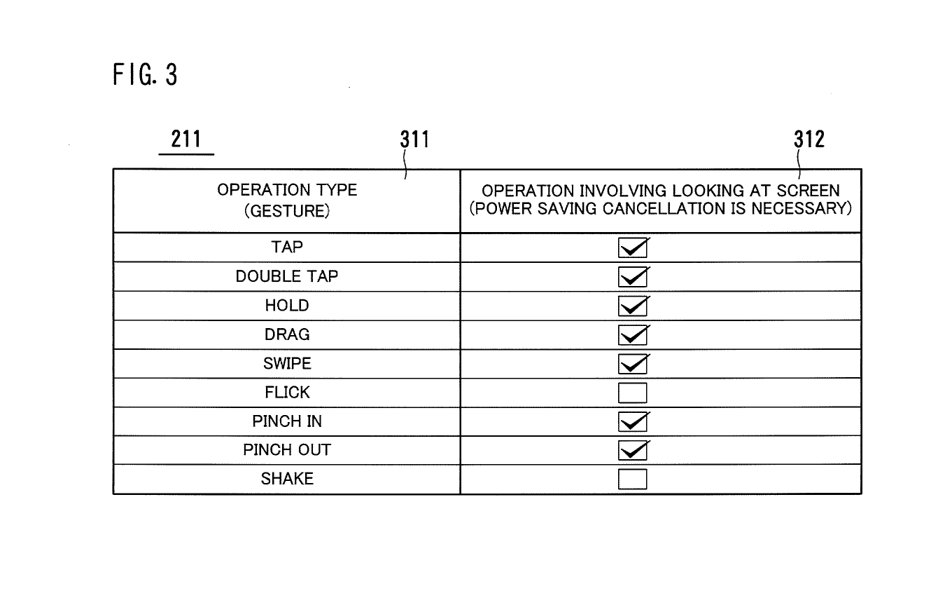

The classification information 211 shows classifications of touch inputs allowed by a user to perform on the touch-sensitive panel 21. To be specific, the classification information 211 shows which operation of “first operation” and “second operation” each of the touch inputs corresponds to. The first operation is defined as operation during which the touch-sensitive panel 21 may display a dim image. The second operation is operation other than the first operation. As shown in FIG. 3, the classification information 211 is provided in the form of a set table having an item 311 named “operation type” and an item 312 named “operation involving looking at screen”.

Referring to FIG. 3, the “operation type” in the item 311 is, for example, “tap”, “double tap”, and “hold” which are distinguished from one another based on user's action, and is also “shake” which is operation of shaking the tablet 1 itself. The item 312 shows whether or not each of the operation in the “operation type” involves looking at a screen. The “operation involving looking at screen” is operation during which a display in the screen should be made more legible. The “operation involving looking at screen” corresponds to the second operation. In FIG. 3, the operation indicated by check mark in the item 312 corresponds to the second operation. In contrast, the operation not indicated by check mark in the item 312 corresponds to operation not classified into the second operation, namely, corresponds to the first operation. In the illustrated example, “flick” and “shake” are classified into the first operation, and the other operation is classified into the second operation.

A user interface may be provided which enables the user to customize the classification information 211. For example, the following known method is used. At first, the table shown in FIG. 3 is displayed. Then, every time the user taps his/her finger on a checkbox of each line of the item 312, a state in which check mark is given and a state in which check mark is not given are switched alternately. In such a case, default classifications are defined in advance, and the user is allowed to use the default classification and also allowed to modify a part thereof. This enables the user to easily customize the classification information 211 and improves the operability.

Referring back to FIG. 2, the operation check portion 212 checks, based on the classification information 211, whether the operation checked by the operation receiving portion 101 corresponds to the first operation or the second operation. To be specific, the operation check portion 212 searches in the classification information 211, and decides that user's operation corresponds to the first operation or that user's operation corresponds to the second operation in accordance with data associated with the type of operation (gesture) performed by the user.

When the operation check portion 212 makes a check, the luminance setting portion 213 takes another look at the set value of luminance which is conveyed to the display drive circuit 23 as a control command of luminance of the touch-sensitive panel 21. The set value is a low luminance value (Low) or a high luminance value (High). At least when the set value is changed, the luminance setting portion 213 conveys the post-change set value to the display drive circuit 23. The display drive circuit 23 reflects the post-change set value immediately in a display made in the touch-sensitive panel 21. When the operation check portion 212 checks that operation by the user corresponds to the first operation, the luminance setting portion 213 does not change the current luminance set value. On the other hand, when the operation check portion 212 checks that operation by the user corresponds to the second operation, the luminance setting portion 213 changes the current set value to a high luminance value greater than a low luminance value, provided that the current set value is a low luminance value corresponding to a value for power-saving. In contrast, if the current set value is a high luminance value, then the luminance setting portion 213 does not change the current set value.

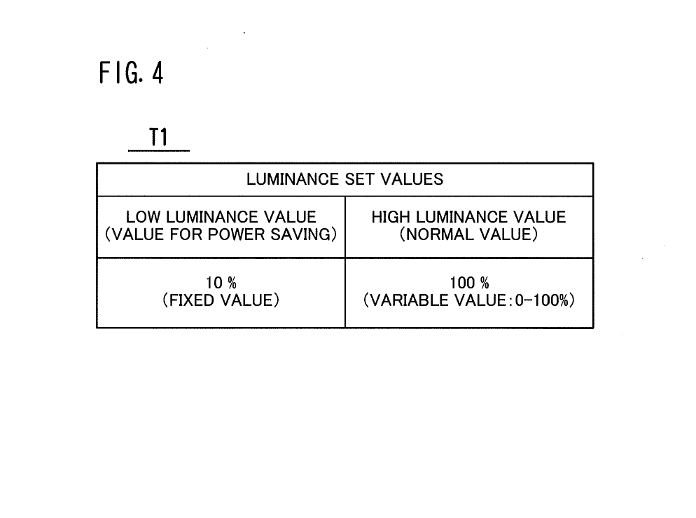

FIG. 4 shows an example of luminance set values. The “high luminance value” set by the luminance setting portion 213 is a value preset, by the user, as the brightness of the screen by using a device setting utility provided in the tablet 1. Such a preset value is called a normal value. The user is allowed to change the normal value according to his/her preference or purpose. The variable range of the normal value in this example is the entire range from the lowest luminance (0%) to the highest luminance (100%). In the example of FIG. 4, the normal value as the high luminance value is set at 100%.

The “low luminance value” set by the luminance setting portion 213 is a fixed value and is set at 10% in the illustrated example. Since the variable range of the normal value includes the range of not more than 10%, it is possible that the high luminance value is smaller than the low luminance value depending on the setting of the normal value. In such a case, the luminance setting portion 213 maintains the luminance set value at a high luminance value (normal value) without changing the value from the high luminance value to the low luminance value, and without changing the value from the low luminance value to the high luminance value.

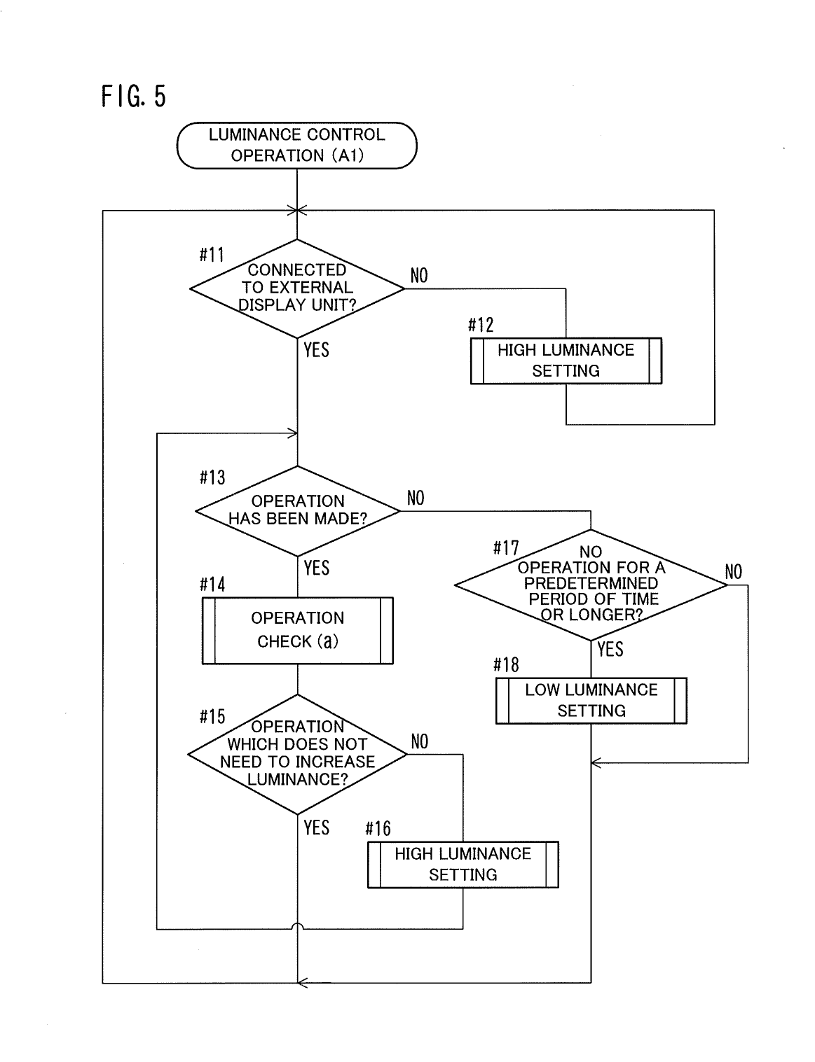

FIG. 5 is a flowchart depicting an example of luminance control operation (A1) in the tablet 1.

The operation check portion 212 confirms whether or not an external display unit is connected to the tablet 1 based on information provided from the external connection management portion 105 (Step #11). At this time, the operation check portion 212 refers to an identification code table for connectable external display units, and checks whether or not the external device connected is a display unit. The operation check portion 212 may have an identification code table, in advance, for display units provided by major manufacturers. The user may register, in advance, an identification code for an external display unit to be used for presentation.

When it is confirmed that no external display unit is connected to the tablet 1 (No in Step #11), the luminance setting portion 213, which has been informed of the fact from the operation check portion 212, performs high luminance setting (Step #12). The high luminance setting is processing for setting a luminance set value at a high luminance value as discussed below. When the high luminance setting is completed, the process goes back to Step #11. Stated differently, in a state where no external display unit is connected to the tablet 1, the application 210 sets a luminance set value always at a high luminance value (normal value).

When it is confirmed that an external display unit is connected to the tablet 1 (YES in Step #11), the operation check portion 212 first obtains information indicating the operation details from the operation receiving portion 101, and confirms whether or not operation has been made (Step #13). If no operation has been performed (NO in Step #13), the operation check portion 212 confirms whether or not no-operation state in which no operation is performed continues for a predetermined period of time (for example, 1 minute) or longer (Step #17). At this time, the operation check portion 212 refers to a timer for counting the time period of the no-operation state. If the timer is OFF, the operation check portion 212 controls the timer to start counting.

If the no-operation state continues for the predetermined period of time or longer (YES in Step #17), then the luminance setting portion 213 performs low luminance setting (Step #18). The low luminance setting is processing for setting a luminance set value at a low luminance value as discussed below. The user is able to change, as he/she likes, the predetermined period of time related to the confirmation as to whether or not no-operation state continues. If the no-operation state is shorter than the predetermined period of time (NO in Step #17), then the process goes back to Step #11.

On the other hand, if the confirmation result “operation has been performed” is obtained in Step #13, then the operation check portion 212 performs operation check (a) processing (Step #14). In this processing, the operation check portion 212 checks, based on the classification information 211, whether the operation checked by the operation receiving portion 101 corresponds to the first operation or the second operation. The operation check portion 212 then conveys the result of check to the luminance setting portion 213.

When receiving the result of check from the operation check portion 212, the luminance setting portion 213 performs luminance setting in accordance with the result of check. To be specific, if the result of check shows that the operation checked by the operation receiving portion 101 corresponds to operation which does not need to increase the luminance, i.e., the first operation (YES in Step #15), then the process goes back to Step #11. If the result of check by the operation check portion 212 shows that the operation checked by the operation receiving portion 101 corresponds to operation which needs to increase the luminance, i.e., the second operation, (NO in Step #15), then the luminance setting portion 213 performs the high luminance setting (Step #16). If the high luminance setting is completed, the process goes back to Step #13.

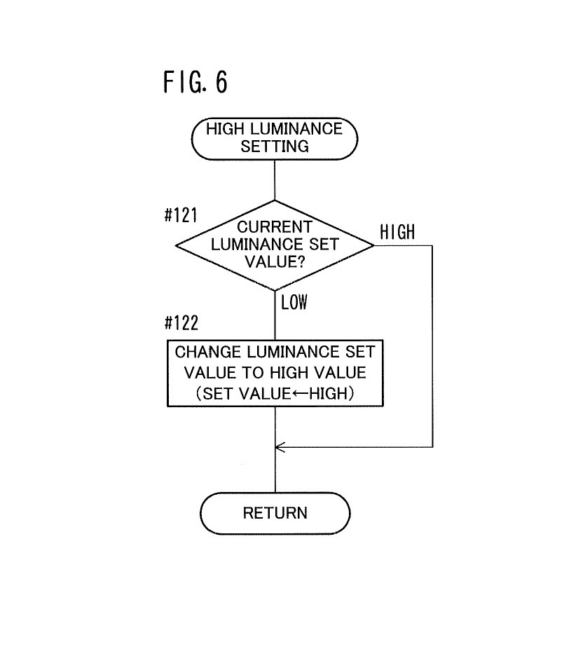

In the high luminance setting in Step #12 and Step #16 of FIG. 5, the processing depicted in FIG. 6 is performed. Referring to FIG. 6, the luminance setting portion 213 checks the current luminance set value (Step #121). If the current set value corresponds to a low luminance value (Low), then the set value is changed to a high luminance value (High) (Step #122). If the current set value corresponds to a high luminance value (High), then no change is made to the set value, and the process goes back to the flow depicted in FIG. 5. At this time, the set value is preferable to be maintained at a high luminance value. The set value may be set again at a high luminance value equal to the current value.

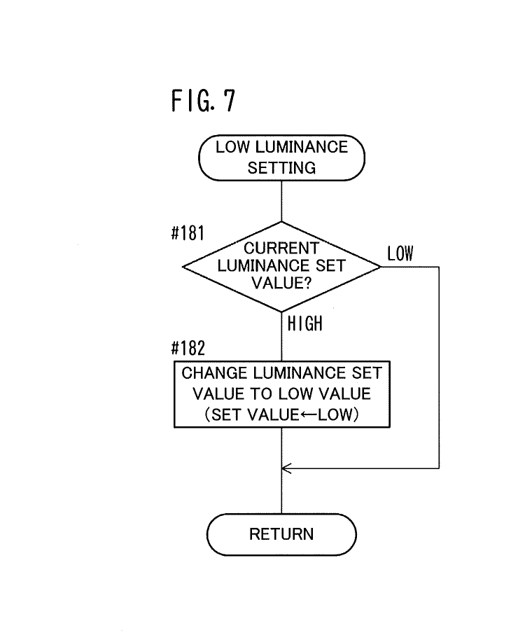

In the low luminance setting in Step #18 of FIG. 5, the processing depicted in FIG. 7 is performed. Referring to FIG. 7, the luminance setting portion 213 checks the current luminance set value (Step #181). If the current set value corresponds to a high luminance value (High), then the set value is changed to a low luminance value (Low) (Step #182). If the current set value corresponds to a low luminance value (Low), then no change is made to the set value, and the process goes back to the flow depicted in FIG. 5. At this time, the set value is preferable to be maintained at a low luminance value. The set value may be set again at a low luminance value equal to the current value.

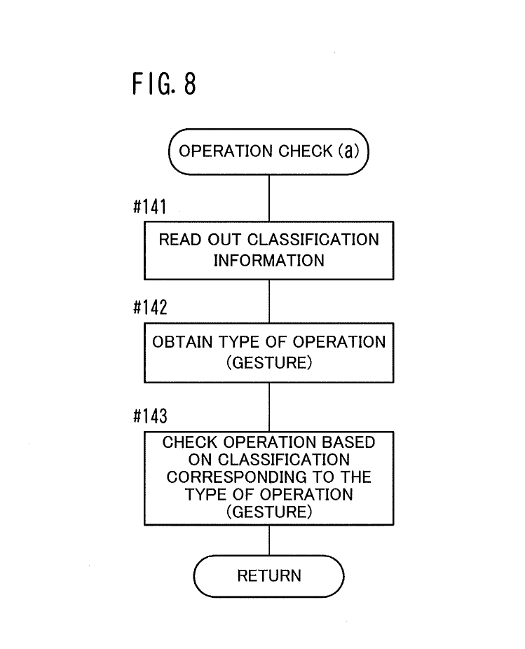

FIG. 8 is a flowchart depicting an example of an operation check routine (a) in the luminance control operation (A1). The operation check portion 212 reads out the classification information 211 from a predetermined memory (Step #141), and obtains a type of the operation from the operation receiving portion 101 (Step #142). The operation check portion 212 then checks whether the operation by the user corresponds to the first operation or the second operation based on the classification shown in the classification information 211 corresponding to the obtained type of the operation (Step #143).

### Modification to the First Embodiment

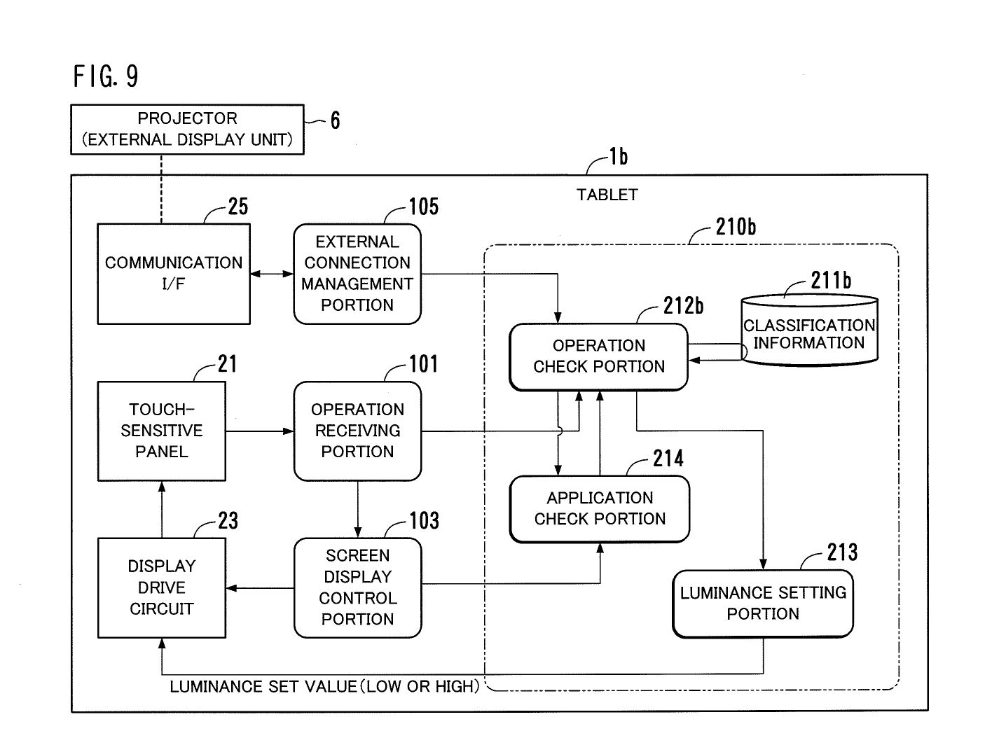

FIG. 9 shows a modification to the functional configuration of the tablet according to the first embodiment. In FIG. 9, elements corresponding to those already described with reference to FIG. 2 are identified with the identical symbols. Hereinafter, the description of those elements is omitted or simplified.

The tablet 1b shown in FIG. 9 has installed thereon an application 210b for power-saving. As compared with the application 210 of FIG. 2, a big feature of the application 210b is that the application 210b has an application check portion 214.

The application check portion 214 is operable to check an application currently operated by a user (operation target application) for a case where a plurality of non-illustrated applications are running thanks to a multi-task function of the operating system. The operation target application is an application corresponding to the foreground window which is a screen visible in the foreground on the touch-sensitive panel 21. The application check portion 214 obtains information related to the foreground window from the screen display control portion 103, and conveys application identification data for identifying the current operation target application (application name thereof, for example) to the operation check portion 212b.

The operation check portion 212b refers to classification information 211b indicating, for each of the installed applications, classifications of operation (touch inputs). The operation check portion 212b then checks whether operation by the user corresponds to the first operation or the second operation. The luminance setting portion 213 sets the luminance depending on the result of check by the operation check portion 212b. The display drive circuit 23 reflects what the luminance setting portion 213 has set immediately in a display made in the touch-sensitive panel 21.

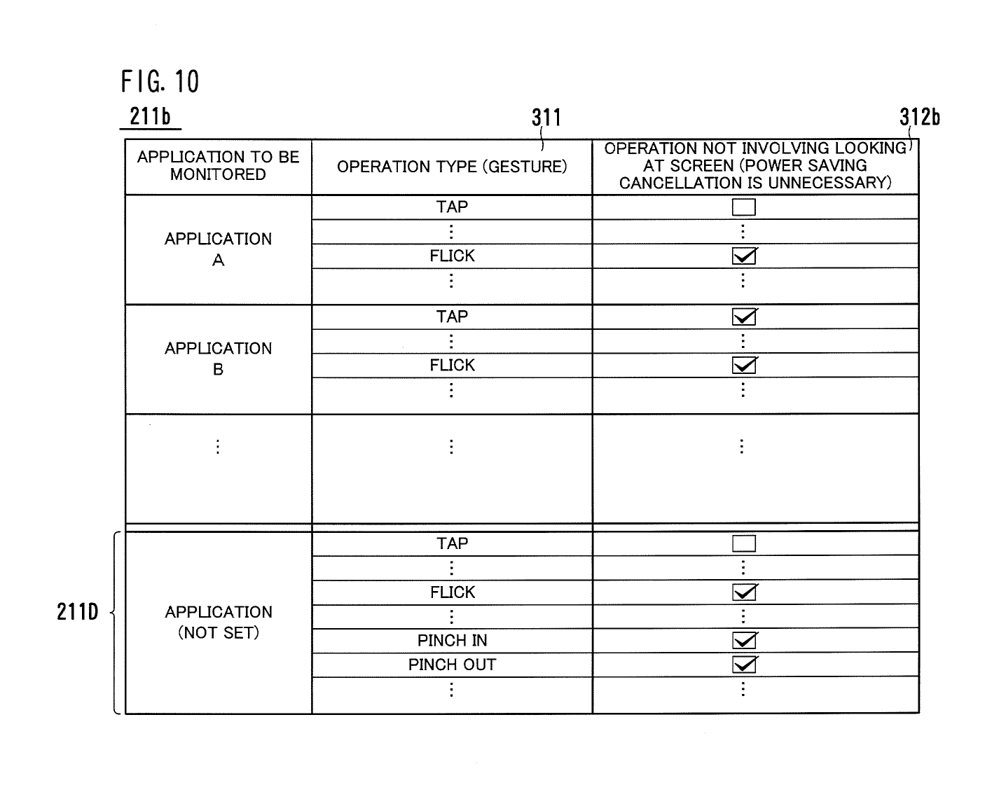

FIG. 10 shows an example of the classification information 211b. The classification information 211b is provided in the form of a set table having the item 311 named “operation type” and an item 312b named “operation not involving looking at screen”. The “operation not involving looking at screen” is operation during which it is not necessary to make a display in the screen more legible. The “operation not involving looking at screen” corresponds to the first operation. In FIG. 10, the operation indicated by check mark in the item 312b corresponds to the first operation. In contrast, the operation not indicated by check mark in the item 312b corresponds to operation not classified into the first operation, namely, corresponds to the second operation.

In the classification information 211b, for each of the applications executable in the tablet 1b, operation distinguished from one another based on user's action itself is classified into the first operation or the second operation. The classification information 211b contains data 211D indicating the default classification. The user is allowed to customize the classification on an application-by-application basis. At this time, the user is allowed to use the default classification as-is, or modify the default classification and use the modified classification.

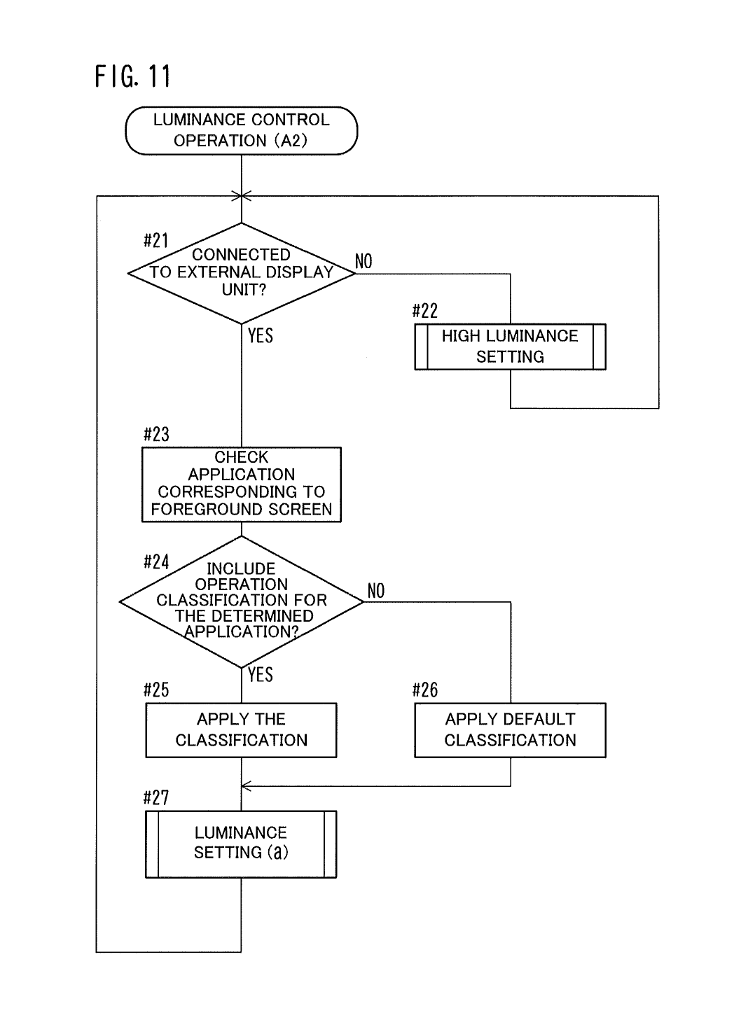

FIG. 11 is a flowchart depicting an example of another luminance control operation (A2) in the tablet 1b shown in FIG. 9 according to the first embodiment.

The operation check portion 212b confirms whether or not an external display unit is connected to the tablet 1b based on information provided from the external connection management portion 105 (Step #21). When no external display unit is connected to the tablet 1b (No in Step #21), the luminance setting portion 213, which has been informed of the fact from the operation check portion 212b, performs high luminance setting (Step #22). The high luminance setting is processing for setting a luminance set value at a high luminance value as depicted in FIG. 6. When the high luminance setting is completed, the process goes back to Step #21.

When an external display unit is connected to the tablet 1b (YES in Step #21), the application check portion 214, which has been informed of the fact from the operation check portion 212b, checks an application that the user operates currently (current operation target) (Step #23). When being informed of the current operation target application, the operation check portion 212b confirms whether or not the classification information 211b contains classification for the current operation target application (Step #24). If the classification information 211b contains classification for the current operation target application (YES in Step #24), then the operation check portion 212b specifies the classification as classification used for the operation check (Step #25). To be specific, the operation check portion 212b specifies a part corresponding to the classification for the current operation target application as a part of the classification information 211b on which attention is focused for the operation check. If the classification information 211b does not contain classification for the current operation target application (NO in Step #24), then the operation check portion 212b determines to use the default classification as classification for the operation check (Step #26). In this way, the classification used for the operation check is determined. After that, the operation check portion 212b and the luminance setting portion 213 perform processing for luminance setting (a) (Step #27).

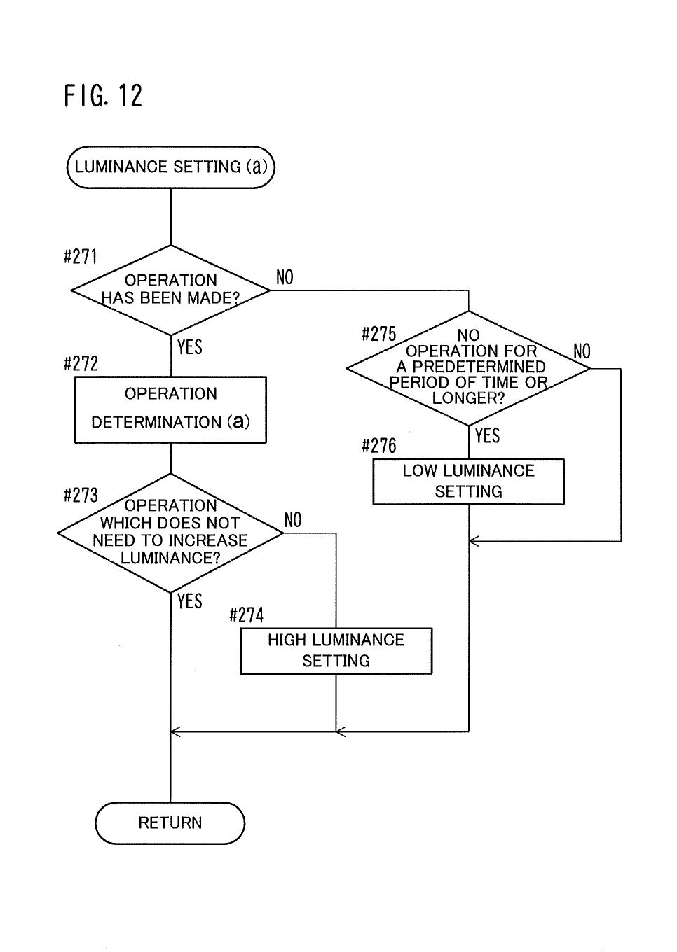

FIG. 12 is a flowchart depicting an example of a luminance setting routine (a) in the luminance control operation (A2). According to the routine, first, the operation check portion 212b obtains information on the operation details from the operation receiving portion 101 to confirm whether or not operation has been performed (Step #271).

If no operation has been performed (NO in Step #271), then the operation check portion 212b confirms whether or not no-operation state in which no operation is performed continues for a predetermined period of time or longer (Step #275). If the no-operation state continues for the predetermined period of time or longer (YES in Step #275), then the luminance setting portion 213 performs the low luminance setting (Step #276). As stated above, the low luminance setting is processing for setting a luminance set value at a low luminance value (see FIG. 7).

On the other hand, if the confirmation result “operation has been performed” is obtained in Step #271, then the operation check portion 212b performs the operation check (a) processing depicted in FIG. 8 (Step #272). In this processing, the operation check portion 212b checks whether the operation checked by the operation receiving portion 101 corresponds to the first operation or the second operation based on the part determined to be used for the operation check. The operation check portion 212b then conveys the result of check to the luminance setting portion 213.

When receiving the result of check from the operation check portion 212b, the luminance setting portion 213 performs luminance setting in accordance with the result of check. If the result of check shows that the operation checked by the operation receiving portion 101 corresponds to operation which does not need to increase the luminance, i.e., the first operation (YES in Step #273), then the process goes back to the flow of FIG. 11. If the result of check by the operation check portion 212b shows that the operation checked by the operation receiving portion 101 corresponds to the second operation (NO in Step #273), then the luminance setting portion 213 performs the high luminance setting (Step #274). As stated above, the high luminance setting is processing for setting a luminance set value at a high luminance value (see FIG. 6).

### Second Embodiment

In the second embodiment, luminance of a touch-sensitive panel is controlled by a subprogram incorporated as an additional functional element into an application that executes a variety of processes involving displaying on the touch-sensitive panel. This arrangement is different from the first embodiment in which luminance of the touch-sensitive panel is controlled by the application specialized for power saving.

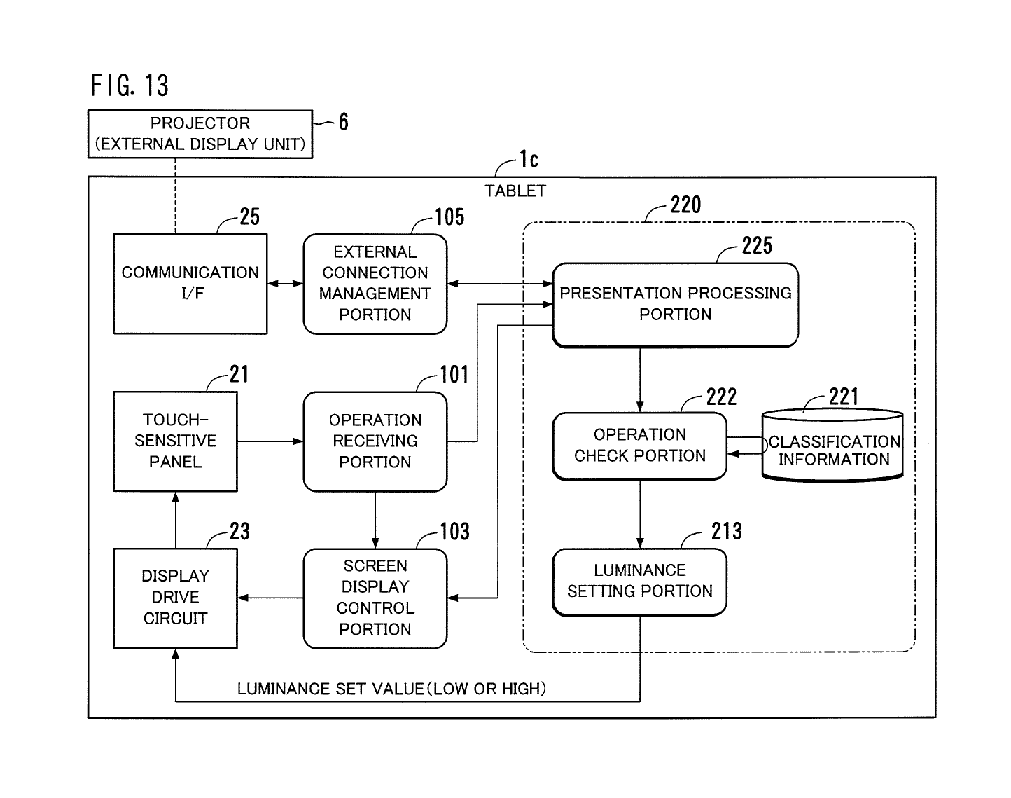

FIG. 13 is a diagram showing an example of the functional configuration of a tablet 1c according to the second embodiment. In FIG. 13, elements corresponding to those already described with reference to FIG. 2 are identified with the identical symbols. The tablet 1c has installed thereon an application 220 for presentation. The tablet 1c is configured of a presentation processing portion 225, classification information 221, an operation check portion 222, a luminance setting portion 213, and so on. The principal element of the application 220 is the presentation processing portion 225. Additional elements of the application 220 are the classification information 221, the operation check portion 222, and the luminance setting portion 213. The additional elements of the application 220 implement a luminance control function for power-saving.

The presentation processing portion 225 offers a presentation mode and a non-presentation mode. The presentation mode enables a dual-display of a document having pages both on the touch-sensitive panel 21 and on an external display unit. The non-presentation mode enables processing for document creation or processing for document editing. In the presentation mode, the presentation processing portion 225 forwards a display made in the touch-sensitive panel on a page-by-page basis, enlarges a page, moves a pointer in a page, and draws a line in accordance with a command given through user's touch operation. The presentation processing portion 225 then conveys the details of the command to the operation check portion 222.

The operation check portion 222 refers to the classification information 221 indicating classifications of operation (touch inputs) distinguished from one another depending on the details of user's command. The operation check portion 222 then checks whether operation performed by the user corresponds to the first operation or the second operation. The luminance setting portion 213 sets the luminance depending on the result of check by the operation check portion 222. The display drive circuit 23 reflects what the luminance setting portion 213 has set immediately in a display made in the touch-sensitive panel 21.

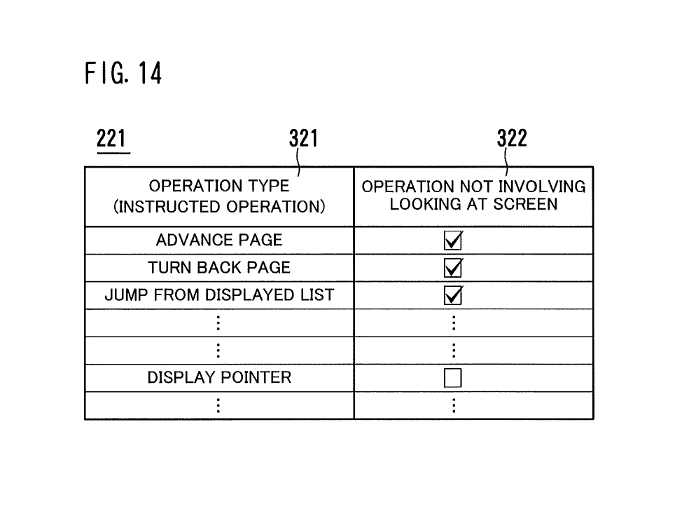

FIG. 14 shows an example of the classification information 221. The classification information 221 is provided in the form of a set table having an item 321 named “operation type” and an item 322 named “operation not involving looking at screen”. The “operation type” in the item 321 does not show the type of touch input itself by the user. The “operation type” in the classification information 221 means the type of operation to be performed by the tablet 1c that has received user's command through his/her touch input. In the illustrated example, the operation type is, for example, advancing page, turning back page, or jumping from displayed list. As discussed earlier, the “operation not involving looking at screen” is operation during which it is not necessary to make a display in the screen more legible. The “operation not involving looking at screen” corresponds to the first operation. The operation indicated by check mark in the item 322 corresponds to the first operation.

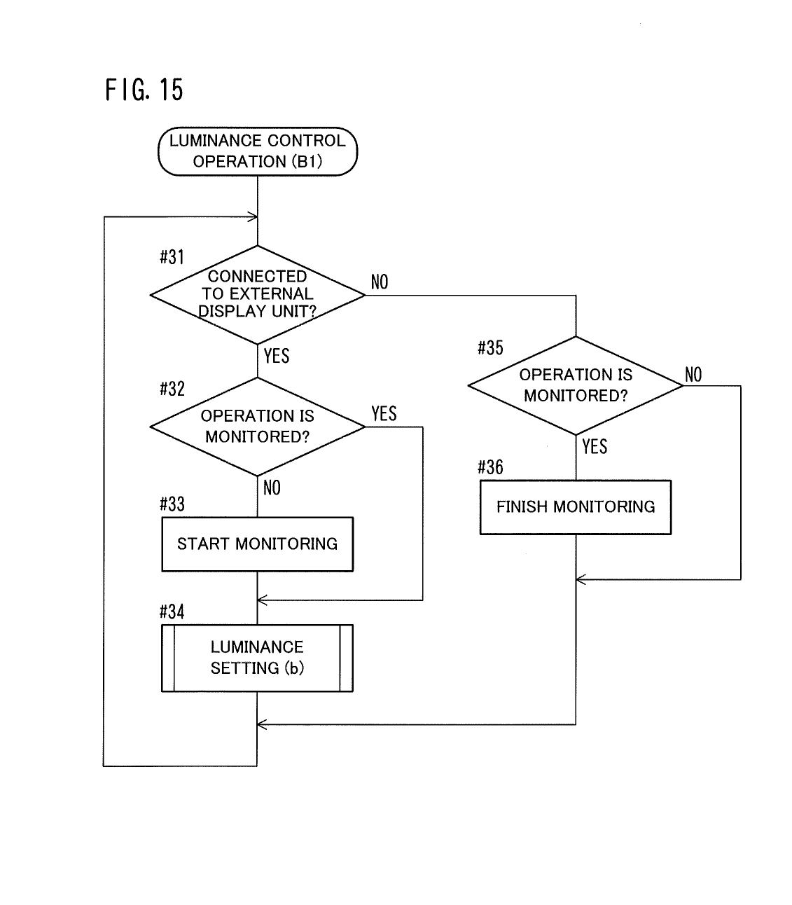

FIG. 15 is a flowchart depicting an example of luminance control operation (B1) in the tablet 1c shown in FIG. 13 according to the second embodiment.

In a state where the presentation mode is selected by the user, the presentation processing portion 225 confirms whether or not an external display unit is connected to the tablet 1c (Step #31). When an external display unit is connected to the tablet 1 (YES in Step #31), the presentation processing portion 225 then confirms whether or not a subprogram for monitoring operation for power saving is running (Step #32). If the subprogram is not running (NO in Step #32), then the presentation processing portion 225 starts the subprogram (Step #33). In response to the operation by the presentation processing portion 225, the operation check portion 222 starts monitoring operation. The execution of the subprogram causes the operation check portion 222 and the luminance setting portion 213 to perform luminance setting processing (b) (Step #34).

Even when an external display unit is not connected to the tablet 1c (NO in Step #31), the presentation processing portion 225 confirms whether or not the subprogram is running (Step #35). Immediately after the tablet 1c is disconnected from the external display unit, the subprogram is still running. In such a case (YES in #305), the presentation processing portion 225 finishes executing the subprogram.

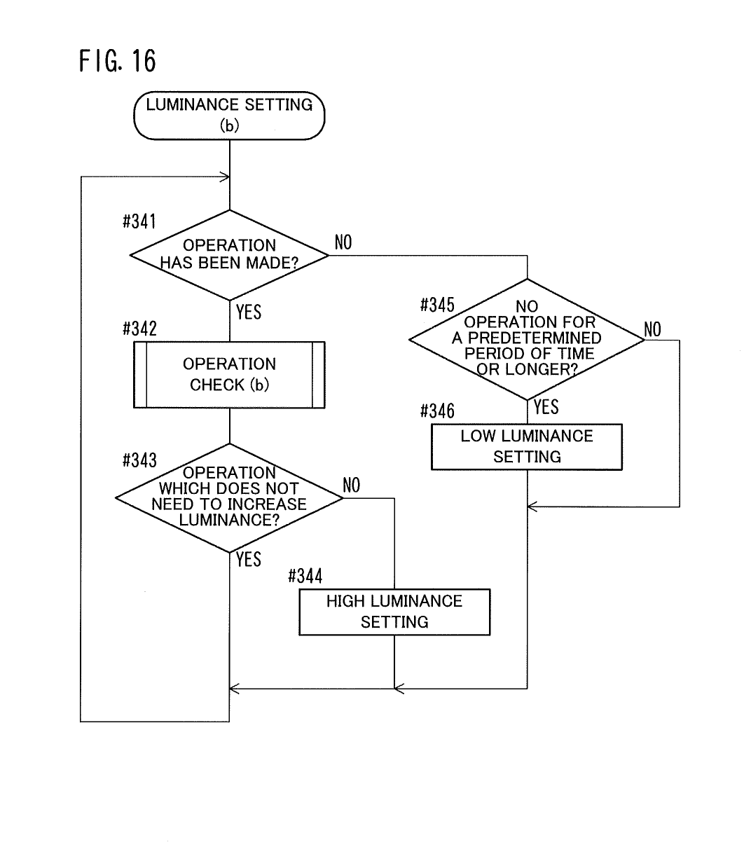

FIG. 16 is a flowchart depicting an example of a luminance setting routine (b) in the luminance control operation (B1) of FIG. 15. According to the routine, first, the operation check portion 222 obtains information on the operation details from the presentation processing portion 225 to confirm whether or not operation has been performed (Step #341).

If no operation has been performed (NO in Step #341), then the operation check portion 222 confirms whether or not no-operation state in which no operation is performed continues for a predetermined period of time (for example, one minute) or longer (Step #345). If the no-operation state continues for the predetermined period of time or longer (YES in Step #345), then the luminance setting portion 213 performs the low luminance setting (Step #346). As stated above, the low luminance setting is processing for setting a luminance set value at a low luminance value (see FIG. 7).

On the other hand, if the confirmation result “operation has been performed” is obtained in Step #341, then the operation check portion 222 performs the operation check (b) processing (Step #342). In this processing, the operation check portion 222 checks whether operation corresponding to a command given by the user to the presentation processing portion 225 corresponds to the first operation or the second operation based on the classification information 221. The operation check portion 222 gives the result of check to the luminance setting portion 213.

When receiving the result of check from the operation check portion 222, the luminance setting portion 213 performs luminance setting in accordance with the result of check. If the result of check shows that the operation checked corresponds to operation which does not need to increase the luminance, i.e., the first operation (YES in Step #343), then the luminance setting portion 213 keeps the current luminance set value. In other words, no change is made to the current luminance set value. The process goes back to Step #341. On the other hand, if the result of check by the operation check portion 222 shows that the operation checked corresponds to the second operation (NO in Step #343), then the luminance setting portion 213 performs the high luminance setting (Step #344). As stated above, the high luminance setting is processing for setting a luminance set value at a high luminance value (see FIG. 6). After the high luminance setting is completed, the process goes back to Step #341.

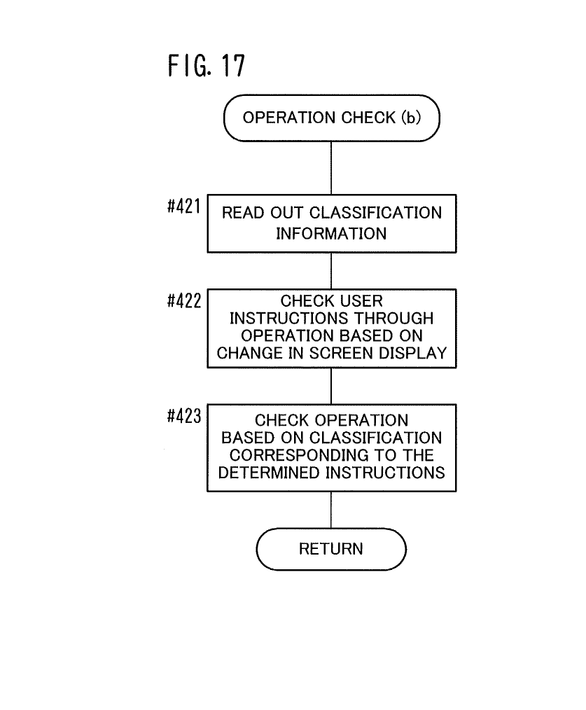

FIG. 17 is a flowchart depicting an example of an operation check routine (b) in the luminance setting routine (b) of FIG. 16. The operation check portion 222 reads out the classification information 221 from a predetermined memory (Step #421). The presentation processing portion 225 checks what kind of command has been given from the user to the presentation processing portion 225 based on the difference between the current screen and a screen that the presentation processing portion 225 requests the screen display control portion 103 to display, i.e., based on the change in display (Step #422). The operation check portion 222 then checks whether the operation performed by the user corresponds to the first operation or the second operation based on classification shown in the classification information 221 corresponding to the user command thus checked (Step #423).

### Modification to the Second Embodiment

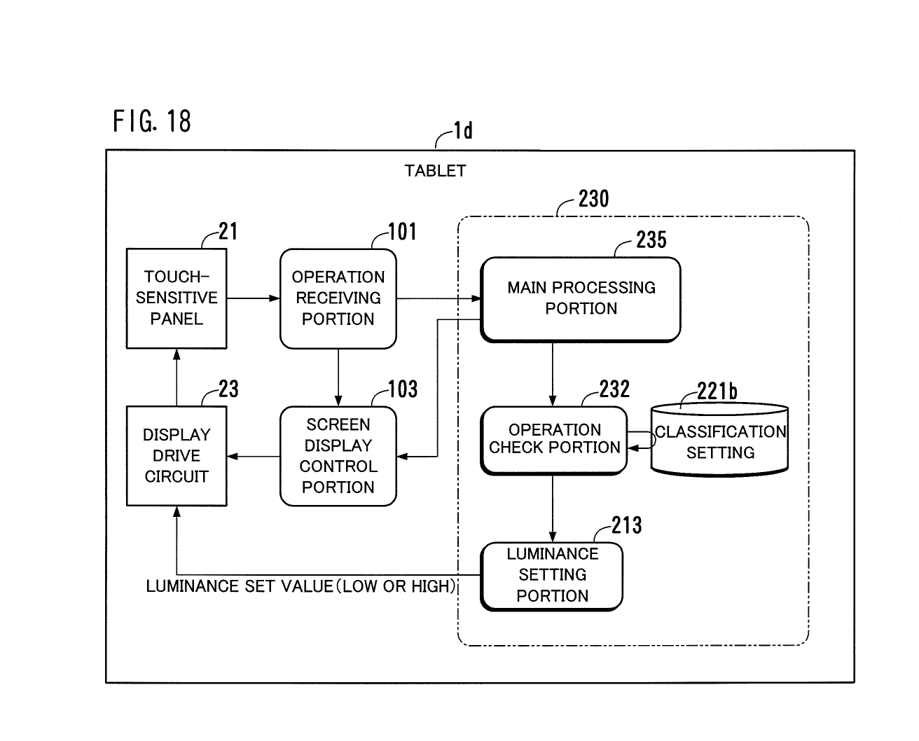

FIG. 18 is a diagram showing a modification to the functional configuration of the tablet according to the second embodiment. In FIG. 18, elements corresponding to those already described with reference to FIG. 2 are identified with the identical symbols.

Referring to FIG. 18, a tablet 1d has installed thereon an application 230 for executing a variety of processes involving displaying on the touch-sensitive panel in accordance with touch inputs. The tablet 1d is configured of a main processing portion 235, classification information 221b, an operation check portion 232, a luminance setting portion 213, and so on. The principal element of the application 230 is the main processing portion 235. Additional elements of the application 230 are the classification information 221b, the operation check portion 232, and the luminance setting portion 213. The additional elements of the application 230 implement a luminance control function for power saving.

The principal function provided by the main processing portion 235 to a user is, for example, a word processing function. Instead of this, the principal function provided by the main processing portion 235 may be any of the functions of spread sheet, Web browsing, filer, and game for business use or personal use. In the case where the main processing portion 235 is not a functional element for dual display including presentation, it is not necessary to connect the tablet 1d to an external display unit.

The main processing portion 235 analyzes the details of operation conveyed by the operation receiving portion 101, and executes processing in accordance with user's instructions. During the processing, the main processing portion 235 asks, if necessary, the screen display control portion 103 to switch between the details displayed. The details of operation for giving instructions to the main processing portion 235 are conveyed from the main processing portion 235 to the operation check portion 232.

When receiving the details of operation, the operation check portion 232 refers to the classification information 221b indicating classifications of operation (touch inputs) that the user is allowed to perform. The operation check portion 232 then checks whether operation performed by the user corresponds to the first operation or the second operation. The luminance setting portion 213 sets the luminance depending on the result of check by the operation check portion 232. The display drive circuit 23 reflects what the luminance setting portion 213 has set immediately in a display made in the touch-sensitive panel 21.

The classification information 221b may be information indicating classifications of operation distinguished from one another based on the type of touch input itself as shown in the example of FIG. 3. Alternatively, the classification information 221b may be information indicating classifications of operation distinguished from one another based on the details of user's command as shown in the example of FIG. 14. In the latter case, the first operation corresponds to, for example, operation for stopping an active process, or closing a window to request the user to make confirmation, i.e., corresponds to operation for giving a command to perform self-contained processing.

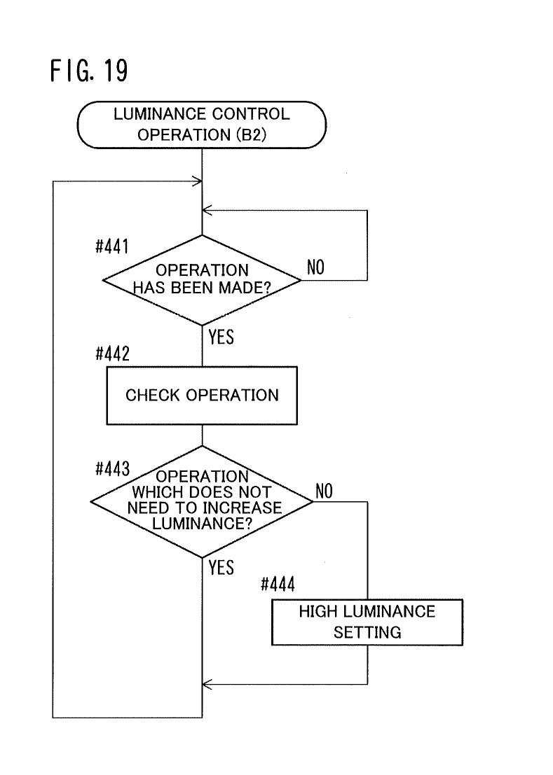

FIG. 19 is a flowchart depicting an example of luminance control operation (B2) in the tablet 1d shown in FIG. 18 according to the second embodiment.

In this routine, the operation check portion 232 waits for some sort of operation to be made to the main processing portion 235 (Step #441). If such operation is made (YES in Step #441), the operation check portion 232 obtains information on the details of operation from the main processing portion 235 to check whether the operation corresponds to the first operation or the second operation based on the classification information 221b (Step #442). If the classification information 221b indicates classifications of operation distinguished from one another based on the type of touch input itself, then the operation check routine (a) shown in FIG. 8 is performed. If the classification information 221b indicates classifications of operation distinguished from one another based on the details of user's command, then the operation check routine (b) shown in FIG. 17 is performed.

If the result of check by the operation check portion 232 shows the first operation (operation which does not need to increase the luminance) (YES in Step #443), then the process goes back to Step #441. If the result of check by the operation check portion 232 shows the second operation (operation which needs to increase the luminance) (NO in Step #443), then the luminance setting portion 213 performs the high luminance setting (Step #444). As discussed earlier, the high luminance setting is processing for setting a luminance set value at a high luminance value (see FIG. 6).

As is clear from FIG. 19, the luminance control operation (B2) does not involve performing low luminance setting. Stated differently, a power-saving function of the application 230 specializes in canceling, only when necessary, the power-saving state in which display on the touch-sensitive panel 21 is set at a low luminance. The tablet 1d has installed thereon software for reducing luminance of displays for the case where no-operation state continues for a predetermined period of time. The software is provided separately from the application 230. The software implements the low luminance setting.

In the first and second embodiments discussed above, the following modifications are also provided.

In the first embodiment, it is possible to classify operation based on the combination of the type of touch input itself and the touched position. For example, tapping on the lower part of the touch-sensitive panel may be defined as the first operation, and tapping on the other parts thereof may be defined as the second operation. This classification is useful in an application in which an operational button often operated by a user without looking at the touch-sensitive panel (e.g., page forward button) is placed on a specific position on the touch-sensitive panel.

In the first embodiment, when the tablet 1 is connected to an external display unit, the luminance set value is kept at a high luminance value except in a case where no-operation state continues for a predetermined period of time or longer. However, the embodiment is not limited to this. Another arrangement is possible in which the tablet 1 is turned into the power-saving state immediately when connection to the external display unit is detected. In such a case, it is preferable that a step for performing the low luminance setting is provided between the processing of Step #11 and the processing of Step #13 in the flowchart of FIG. 5. Likewise, it is preferable that a step for performing the low luminance setting is provided between the processing of Step #21 and the processing of Step #23 in the flowchart of FIG. 11. This reduces the power consumption of the touch-sensitive panel 21 immediately when the projector 6 or another external display unit is connected to the tablet 1, which extends the battery life.

In the second embodiment also, the tablet 1c may be turned into the power-saving state right after the connection to an external display unit is detected. In such a case, it is preferable that, in the flowchart of FIG. 15, a step for performing the low luminance setting is provided right after the processing of Step #33 for starting a subprogram.

In the tablet 1c of the second embodiment, the presentation processing portion 225 starts the subprogram for power-saving. Instead of this, the start service program of the tablet 1c may be arranged in such a manner that a subprogram for power-saving is started at a time when an external display unit is connected to the tablet 1c.

In the first and second embodiments, provided that the tablets 1, 1b, and 1c are used only for connection to an external display unit, the following arrangement is possible. To be specific, while some sort of external device is connected to the tablet, the luminance control may be performed without making a determination as to whether or not the external device connected to the tablet is a display unit.

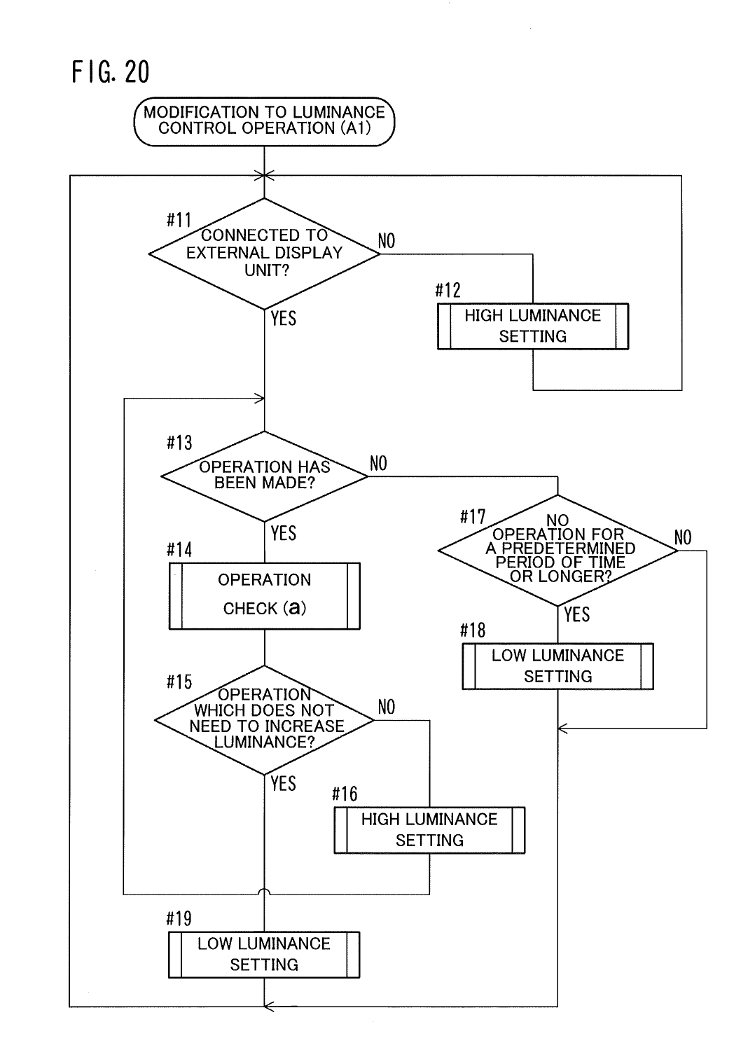

When it is checked that user's operation corresponds to the first operation, the set value may be forcedly changed to a low luminance value irrespective of the current luminance set value. To be specific, if the result of check is “YES” in Step #15 of FIG. 5, Step #273 of FIG. 12, Step #343 of FIG. 16, or Step #443 of FIG. 19, the low luminance setting may be performed successively. FIG. 20 shows a modification to the flowchart of FIG. 5. In FIG. 20, Step #19 for performing the low luminance setting is added.

Suppose that, when the first operation is made, the luminance set value is forcedly changed to a low luminance value. Under this state, when the first operation and the second operation are made alternately and successively, displays made in the touch-sensitive panel 21 are changed to be dim and bright repeatedly as if the display made therein flashes, which lowers the legibility. To cope with this, changing from a high luminance value to a low luminance value is not performed until a predetermined amount of time has elapsed since the high luminance value was displayed. Stated differently, changing the luminance value is not performed so frequently during a short period of time. This enhances the effect of power-saving and also prevents the low legibility on display.

The details of the classification information 211, 211b, 221, and 221b may be set appropriately depending on what is to be operated. For example, when an application to be operated is a word processing application, the first operation is cursor movement, page scrolling, and so on. The classification information 211, 211b, 221, and 221b indicate, at least, that operation made by a user corresponds to the first operation or the second operation. Each set of the classification information 211, 211b, 221, and 221b may indicate only operation classified into the first operation, or, only operation classified into the second operation.

Instead of fixing the low luminance value which is one luminance set value, the low luminance value may be identified in the form of a ratio of the low luminance value to the high luminance value (normal value). In such a case, the absolute value of the low luminance value varies depending on the setting of the high luminance value. The ratio may be fixed at, for example, 50% (half of the high luminance value). Alternatively, the ratio may be a variable changing depending on the high luminance value. The effect of power-saving is achieved basically by setting the low luminance value to be smaller than the high luminance value. Each of the high luminance value and the low luminance value may be set at a fixed value.

The functional configuration, hardware configuration, and operation of the tablet 1, 1b, 1c, and 1d may be changed appropriately within the scope of the invention. For example, the pointing device of the touch-sensitive panel 21 may be formed to detect only single-touch input. In such a case, multi-touch input such as pinch-in or pinch-out does not correspond to operation that a user is allowed to perform.

The present invention is applicable not only to a tablet but also to a smartphone, another mobile information device having a touch-sensitive panel used for display and operation, and a laptop personal computer having a display unit onto which a touchpad pointing device is attached.

According to the present invention, switching from low luminance to high luminance is controlled in accordance with preset classifications for operation performed through a touch-sensitive panel. This enables reduction in power consumption due to unnecessary high luminance display.

While example embodiments of the present invention have been shown and described, it will be understood that the present invention is not limited thereto, and that various changes and modifications may be made by those skilled in the art without departing from the scope of the invention as set forth in the appended claims and their equivalents.

1. An information device comprising:
a display panel that is configured to display images;
an input receiving device for receiving an input from a user of the information device;
an operation determining portion configured to determine, based on the input received by the input receiving device, whether an operation performed on the information device is within a first category of operations or within a second category of operations, different than the first category of operations; and
a luminance setting portion configured to:
when a luminance set value of the touch-sensitive panel is at a first luminance value, and when the operation determining portion determines that an operation performed on the information device is within the first category of operations, maintain the luminance set value unchanged, and
when the luminance set value is set at the first luminance value, and when the operation determining portion determines that the operation performed on the information device is within the second category of operations, set the luminance set value to a second luminance value that is greater than the first luminance value.

2. The information device according to claim 1, wherein the luminance setting portion sets, as the luminance set value, the first luminance value when no operation is performed during a predetermined period of time.

3. The information device according to claim 1, further comprising an interface configured to connect the information device to an external display unit for displaying an image displayed on the display panel;
wherein the operation determining portion checks whether an operation performed on the information device is within the first category of operations or is within the second category of operations only while the information device is connected to the external display unit via the interface.

4. The information device according to claim 1, further comprising a storage portion configured to store therein classification information including classifications, the classification information indicating which category each of user inputs corresponds to, the user inputs being an operation that a user is allowed to perform on the information device;
wherein the operation determining portion checks whether the operation performed on the information device is within the first category of operations or is within the second category of operations based on the classification information.

5. The information device according to claim 4, further comprising an application determining portion configured to determine what application software corresponds to a foreground window displayed on the touch-sensitive panel;
wherein the classification information includes classifications indicating which of the first category of operations and the second category of operations each of the user inputs corresponds to for each piece of application software executable in the information device, and
the operation determining portion checks whether the operation performed on the information device is within the first category of operations or is within the second category of operations based on a classification, included in the classification information, for the application software determined by the application determining portion.

6. The information device according to claim 5, wherein, if the classification information does not include the classification for the application software determined by the application determining portion, the operation determining portion checks whether an operation performed on the information device is within the first category of operations or is within the second category of operations based on a default classification included in the classification information.

7. The information device according to claim 4, wherein the user inputs are touch inputs performed on the display panel, and
the classification information is to classify each of the user inputs based on types of the touch inputs.

8. The information device according to claim 4, wherein the classification information is to classify each of the user inputs based on user instructions corresponding to the user inputs.

9. The information device according to claim 4, wherein the classification information lists user inputs classified into the first category of operations.

10. The information device according to claim 4, wherein the classification information lists user inputs classified into the second category of operations.

11. A non-transitory computer-readable storage medium storing thereon a computer program executed in an information device having a display panel that is used for display, the computer program causing a computer provided in the information device to perform processing comprising:
operation determining processing of determining whether an operation performed on the information device is within a first category of operations or is within a second category of operations other than the first category of operations; and
luminance setting processing of:
when a luminance set value of the display panel is at a first luminance value, and when it is determined in the operation determining processing that the operation performed on the information device is within the first category of operations, maintaining the luminance set value unchanged, and
when the luminance set value is set at the first luminance value, and when it is determined in the operation determining processing that the operation performed on the information device is within the second category of operations, setting the luminance set value to a second luminance value that is greater than the first luminance value.

12. The non-transitory computer-readable storage medium according to claim 11, wherein the operation determining processing includes determining whether the operation performed on the information device is within the first category of operations or is within the second category of operations only while the information device is connected to an external display unit for displaying an image displayed on the display panel.

13. The non-transitory computer-readable storage medium according to claim 11, wherein
the computer program further causes the computer to perform application determining processing of determining what application software corresponds to a foreground window displayed on the display panel, and
the operation determining processing includes determining, for each piece of application software executable in the computer, whether an operation performed on the information device is within the first category of operations or is within the second category of operations based on classifications, included in classification information, for the application software determined in the application determining processing, the classification information indicating which of the first category of operations and the second category of operations each of user inputs corresponds to, the user inputs being operation that a user is allowed to perform on the information device.

14. The non-transitory computer-readable storage medium according to claim 13, wherein, if the classification information does not include the classification for the application software determined in the application determining processing, the operation determining processing includes determining whether the operation performed on the information device is within the first category of operations or is within the second category of operations based on a default classification included in the classification information.

15. An information device comprising:
a display panel that is used for display;
an operation determining portion configured to determine whether an operation performed on the information device is within a first category of operations or is within a second category of operations other than the first category of operations; and
a luminance setting portion configured to, when the operation determining portion determines that the operation performed on the information device is within the first category of operations, set a first luminance value as a luminance set value of the display panel, and, when the operation determining portion determines that the operation performed on the information device is within the second category of operations, set the luminance set value to a second luminance value that is greater than the first luminance value.

16. A non-transitory computer-readable storage medium storing thereon a computer program executed in an information device having a display panel that is used for display, the computer program causing a computer provided in the information device to perform processing comprising:
operation determining processing of determining whether an operation performed on the information device is within a first category of operations or is within a second category of operations other than the first category of operations; and
luminance setting processing of, when it is determined in the operation determining processing that the operation performed on the information device is within the first category of operations, setting a first luminance value as a luminance set value of the display panel, and, when it is determined in the operation determining processing that the operation performed on the information device is within the second category of operations, setting the luminance set value to a second luminance value that is greater than the first luminance value.

17. The information device according to claim 3, wherein the operation determining portion determines whether the operation performed on the information device is within the first category of operations or is within the second category of operations only while the information device is placed in a presentation mode during which an image on the display panel is displayed also on the external display unit.

18. The non-transitory computer-readable storage medium according to claim 12, wherein the operation determining processing includes determining whether the operation performed on the information device is within the first category of operations or is within the second category of operations only while the information device is placed in a presentation mode during which an image on the display panel is displayed also on the external display unit.

19. The information device according to claim 1, wherein the first luminance value is for power saving.

20. The non-transitory computer-readable storage medium according to claim 11, wherein the first luminance value is for power saving.

21. The information device according to claim 15, wherein the first luminance value is for power saving.

22. The non-transitory computer-readable storage medium according to claim 16, wherein the first luminance value is for power saving.

23. The information device according to claim 1, wherein the display panel is a touch-sensitive panel used for display and operation.

24. The non-transitory computer-readable storage medium according to claim 11, wherein the display panel is a touch-sensitive panel used for display and operation.

25. The information device according to claim 15, wherein the display panel is a touch-sensitive panel used for display and operation.

26. The non-transitory computer-readable storage medium according to claim 16, wherein the display panel is a touch-sensitive panel used for display and operation.
